(19) United States
(12) Patent Application Publication
(10) Pub. No.: US 2006/0066633 A1
(43) Pub. Date: Mar. 30, 2006

(54) Method and apparatus for processing on-screen display data

(75) Inventor: Young-hoon Jeong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/205,193

(22) Filed: Aug. 17, 2005

(30) Foreign Application Priority Data
Sep. 30, 2004 (KR) 10-2004-0077728

(51) Int. Cl. H04N 5/262; H04N 9/74

(52) U.S. Cl. 345/619; 348/578; 715/810; 348/239

(57) ABSTRACT

A method and apparatus for processing on-screen display (OSD) data are provided. The method includes processing basic OSD data to yield processed OSD data that can be displayed with a certain visual effect.

This application claims priority from Korean Patent Application No. 10-2004-0077728, filed on Sep. 30, 2004, in the Korean Intellectual Property Office, the disclosure of which is incorporated herein in its entirety by reference.

### BACKGROUND OF THE INVENTION

1. Field of the Invention

Apparatuses and methods consistent with the present invention relate to On-Screen Display (OSD) technology, and more particularly, to processing OSD data, in a device connected to an external video display unit, such as a flat panel display or a Cathode Ray Tube (CRT). Examples of such a device are a digital camera, digital camcorder, and any multimedia device using OSD as a Graphic User Interface (GUI).

2. Description of the Related Art

An OSD is employed in a variety of digital devices to graphically display system-related data or visual media.

FIG. 1 is a block diagram of a conventional video display system.

Referring to FIG. 1, the system includes a microprocessor 110, an OSD and graphics generator 120, a post-processor 130, a video display controller 140, a system bus 150, a master 160, a memory 170, and first through N^{th} display units 180-190.

The microprocessor 10 sends parameters to the OSD and graphics generator 120 to generate OSD information to be displayed on a screen. The OSD information can be text information, location information, or two-dimensional graphics information.

The OSD and graphics generator 120 receives and interprets parameters, and reads out corresponding texts or patterns from an internal memory 122 in the form of a read-only memory (ROM), or an external memory 121 or 170 in the form of a ROM or a random access memory (RAM). The OSD and graphics generator 120 may also be incorporated into the post-processor 130.

The post-processor 130 outputs to the video display controller 140 display data resulting from mixing video data with OSD information or graphics information received from the OSD and graphic generator 120.

The video display controller 140 adjusts the display data to be fit for display on each of the display units 180 through 190, and outputs each result with a control signal to each display unit.

FIG. 2 is a block diagram of the post-processor 130 of FIG. 1.

Referring to FIG. 2, the post-processor 130 includes a mixer 141.

The internal memory 122 or external memory 121 or 170 stores in advance letters, color tables, various icons, and/or graphics available for the OSD information, which are mixed with video data by the mixer 141 in the post-processor 130.

The internal or external memory may also store a variety of fonts to support numerous languages, as well as numerous special symbols. The amount of data stored may be customized in some applications, but once stored in memory the data cannot be changed or updated, therefore most conventional applications store as many fonts and special symbols as possible just in case they are needed at some point.

In addition, the memory may also store additional information used for special effects, such as a cubic effect, border emphasis, and turnover, which requires significant memory space and leads to a rise in production cost.

In regard to special effects, the OSD or graphics information is displayed over top of the video data, and therefore needs to be emphasized in order to clearly distinguished from the video data. Methods of emphasizing the OSD or graphics information include borderline emphasis, multi-level, and using different colors, and the best method is normally chosen based on video display characteristics, the display background, etc. However, in the conventional video display device, since fonts, symbols, and special effects data are generally stored in advance in an offline state and recalled when needed, they cannot be altered or supplemented and special effects cannot be made appropriate for various external conditions.

### SUMMARY OF THE INVENTION

The present invention provides a method and apparatus for processing OSD data which uses a minimum amount of information to display the OSD data with a certain visual effect, and thereby reduces memory space required to store fonts, icons, special symbols, etc.

According to an aspect of the present invention, there is provided a method of processing OSD data, comprising: processing basic OSD data to yield processed OSD data that can be displayed with a certain visual effect.

According to an aspect of the present invention, processing the basic OSD data comprises performing convolution on the basic OSD data.

According to an aspect of the present invention, performing convolution comprises: providing filter information; and performing the convolution on the basic OSD data using the filter information.

According to an aspect of the present invention, providing the filter information comprises: selecting a filter to be used for the convolution; and adjusting filter coefficients of the filter.

According to an aspect of the present invention, the filter includes at least one of a filter that creates a border detection effect, a filter that creates an outlining effect, a filter that creates a shading effect, and a filter that creates a blurring effect.

According to an aspect of the present invention, the method further comprises: mixing the processed OSD data with video data to display the mixed result.

According to another aspect of the present invention, there is provided an apparatus for processing OSD data, comprising: an OSD processor processing basic OSD data to yield processed OSD data that can be displayed with a certain visual effect.

According to an aspect of the present invention, the OSD processor performs a convolution on the basic OSD data.

According to an aspect of the present invention, the OSD processor comprises: a filtering unit providing filter information; and a convolution and image processor performing the convolution on the basic OSD data using the filter information.

According to an aspect of the present invention, the filtering unit comprises: a filter selector selecting a filter to be used for the convolution; and a filter coefficient controller adjusting filter coefficients of the filter.

According to an aspect of the present invention, the filter includes at least one of a filter that creates a border detection effect, a filter that creates an outlining effect, a filter that creates a shading effect, and a filter that creates a blurring effect.

According to an aspect of the present invention, the apparatus further comprises: a mixer mixing the processed OSD data with video data to display the mixed result.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a conventional video display device;

FIG. 2 is a block diagram illustrating a post-processor of FIG. 1;

FIG. 3 is a block diagram illustrating an apparatus for processing video and OSD data, according to an exemplary embodiment of the present invention;

FIGS. 4A through 4G are illustrations for explaining a filtering method employed in exemplary embodiments of the present invention;

FIGS. 5A through 5E are illustrations for explaining an exemplary embodiment of a filtering method employed in the present invention; and

FIGS. 6A through 6D show the results of applying various effects to an OSD, according to exemplary embodiments of the present invention.

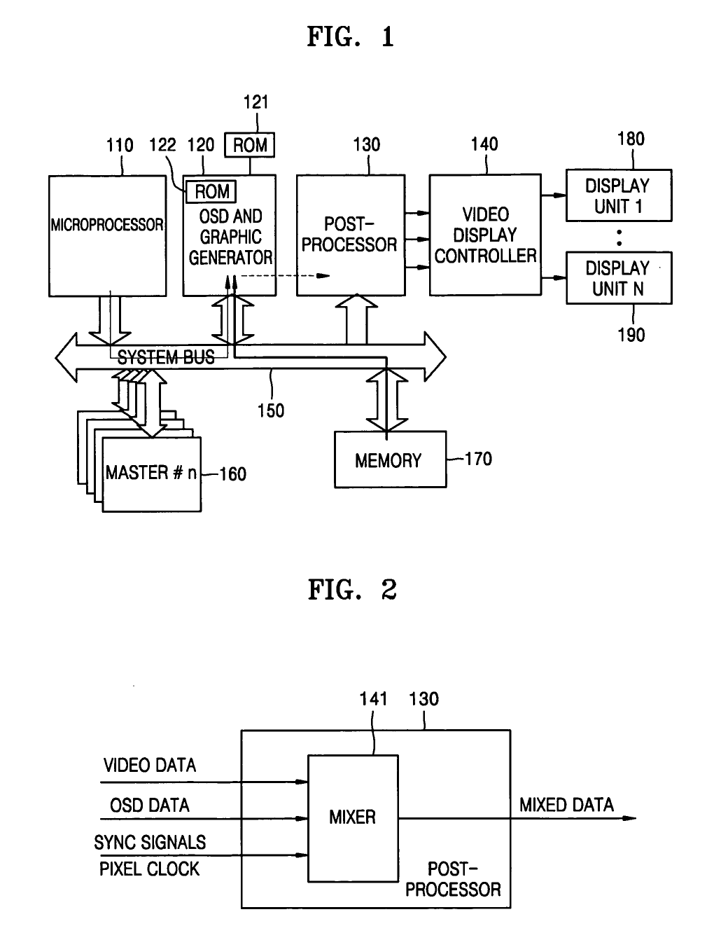

### DETAILED DESCRIPTION OF EXEMPLARY EMBODIMENTS OF THE INVENTION

Exemplary embodiments of the present invention will now be described in detail with reference to the attached drawings.

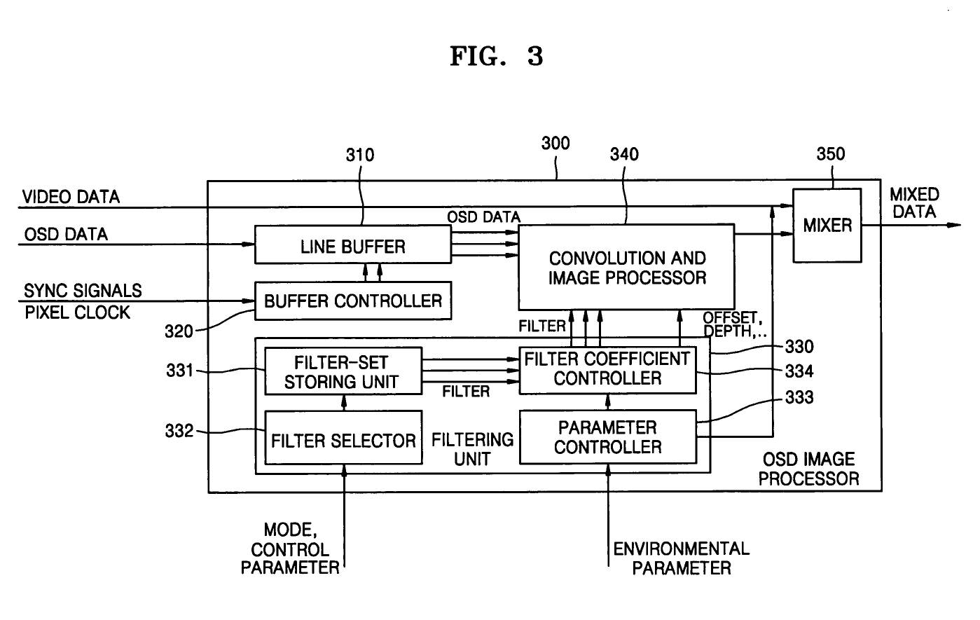

FIG. 3 is a block diagram illustrating an apparatus 300 for processing video and OSD data, according to an exemplary embodiment of the present invention.

Referring to FIG. 3, the apparatus includes a line buffer 310, a buffer controller 320, a filtering unit 330, a convolution and image processor 340, and a mixer 350.

The apparatus may be embodied as a separate OSD and graphics generator, and may also be incorporated into the post-processor 130. Also, the mixer 350 included in the apparatus can be separated from but externally connected to the apparatus.

The line buffer 310 stores basic OSD data read from a memory (not shown). The basic OSD data stored in the line buffer 310 amounts to at least one line of a screen. Here, the term “basic OSD data” means original OSD data before being filtered to gain a certain effect.

The buffer controller 320 receives control signals and clocks from an external source, and controls the line buffer 310 to store a predetermined amount of OSD data and output the stored OSD data to the convolution and image processor 340.

The filtering unit 330 provides the convolution and image processor 340 with filter information to give a specific effect to the original OSD data. The filtering unit 330 will be described in more detail later.

The convolution and image processor 340 receives the basic OSD data from the line buffer 310 and the filter information from the filtering unit 330, to perform convolution on the basic OSD data based on the filter information, or to use the result of the convolution, processed OSD data, to generate various effects on the OSD data display.

The mixer 350 mixes video data input from the outside with the OSD data processed by the convolution and image processor 340.

The filtering unit 330 includes a filter-set storage unit 331, a filter selector 332, a parameter controller 333, and a filter coefficient controller 334.

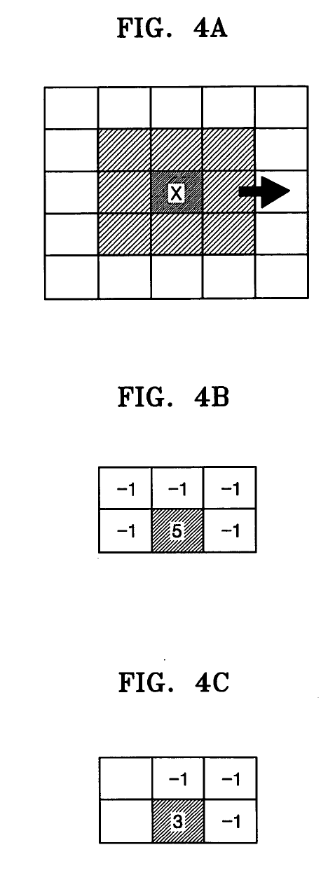

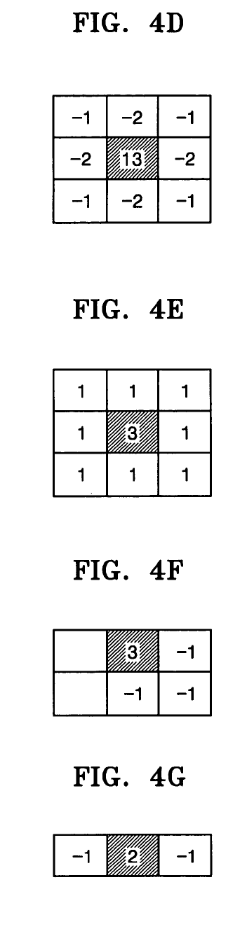

The filter-set storage unit 331 stores a set of filters used for creating various visual effects. The filters can be, for example, two-dimensional filters as shown in FIG. 4B through 4G.

Convolution, commonly used for image smoothing, image sharpening, edge detection, etc., corresponds to a sum of weighted values of pixels neighboring an input pixel. The weighted values are given in a small two-dimensional array. A convolution window is centered on each pixel in an input picture to generate new output pixel values. Pixels within the convolution window are each multiplied by corresponding weighted values of a convolution mask and the products are added with each other.

FIG. 4A shows an input picture consisting of pixels before being filtered, in which a shaded area of 3x3 pixels denotes the convolution window.

FIG. 4B is an illustration for explaining a filter that creates an effect of border detection by multiplying the value of a pixel to be output by 5, multiplying the values of five neighboring pixels by −1, and then summing the products.

FIG. 4C is an illustration for explaining a filter that creates an effect of directional shading by multiplying a pixel value to be output by 3, multiplying three neighboring pixels by −1, and then summing the products.

FIG. 4D is an illustration for explaining a filter that creates an outline effect by multiplying a pixel to be output by 13, multiplying neighboring pixels by −1 or −2, and summing the products.

FIG. 4E is an illustration for explaining a filter that creates a blurring effect by multiplying a pixel to be output by 3, multiplying neighboring pixels by 1, and summing the products.

FIG. 4F is an illustration for explaining another filter that creates an effect of directional shading by multiplying a pixel to be output by 3, multiplying three neighboring pixels by −1, and summing the products.

FIG. 4G is an illustration for explaining a filter that creates a side-outline effect by multiplying a pixel to be output by 2, multiplying two neighboring pixels by −1, and summing the products.

The filter selector 332 selects and outputs filter coefficients that correspond to one of the plurality of filters stored in the filter-set storing unit 331, depending on a mode and control parameters input from outside.

The parameter controller 333 analyzes environmental parameters received from the outside, and transforms the environmental parameters to match the filter coefficient controller 334. For example, when filter coefficients for creating an outline effect have been selected, it may sometimes be necessary to apply the outline effect more gradually by modifying the filter coefficients. Accordingly, the parameter controller 333 transforms environmental parameters so that they can be interpreted by the filter coefficient controller 334, which then modifies the filter coefficients as necessary.

The filter coefficient controller 334 modifies the filter coefficients received from the filter-set storage unit 331 based on parameters output by the parameter controller 333, and outputs the result to the convolution and image processor 340.

Operation of the apparatus 300 for processing video and OSD data according to the present invention is described below.

First, the apparatus 300 receives OSD data, video data, various clock and control signals, and parameters that indicate a type of effect with which the OSD data is to be displayed, intensity of the effect, etc.

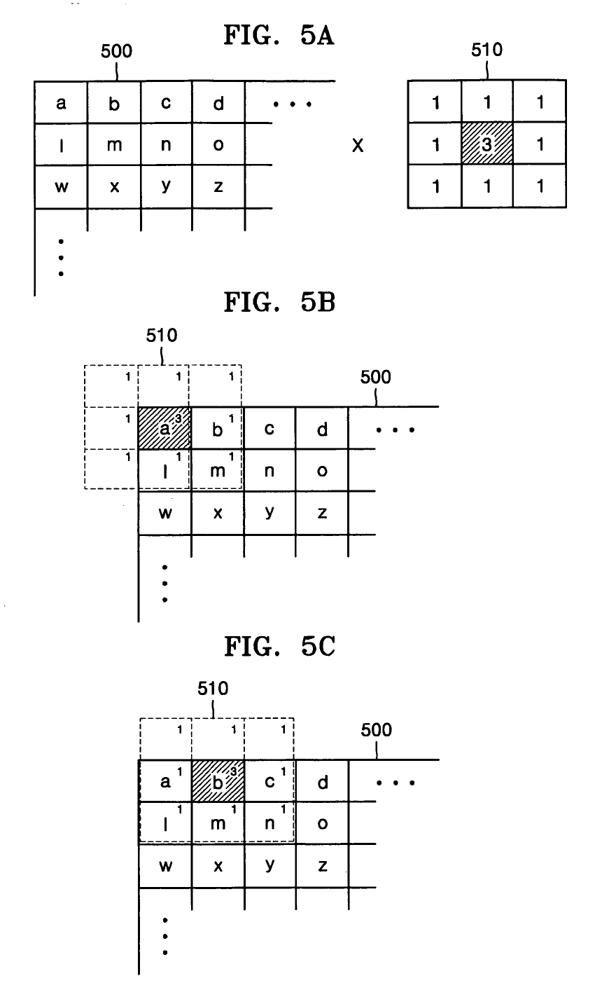

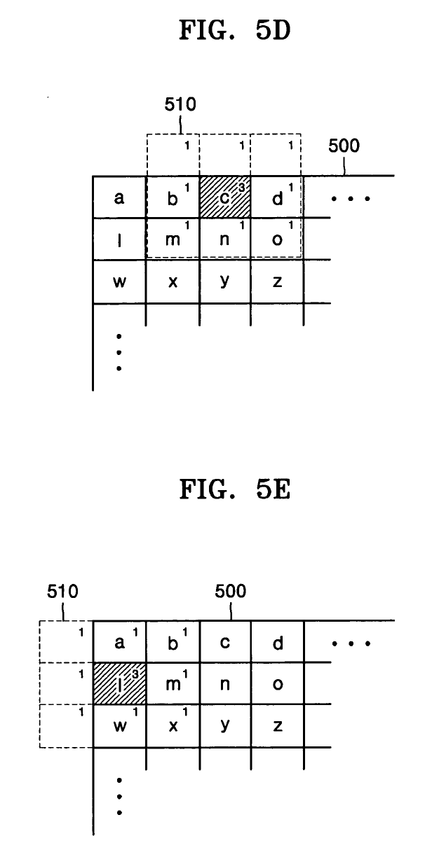

A memory control signal is generated by the buffer controller 320 based on the clocks and control signals, and more than one line of OSD data input from the outside is stored in the internal line buffer 310. For example, as shown in FIG. 5A, if a 3×3 filter 510 for creating a blurring effect is used, the line buffer 310 stores at least three lines of information about an input picture 500.

The filter selector 332 receives the type of effect for the OSD data, the intensity of the effect, and control parameters from the outside. The parameter controller 333 receives environmental parameters from the outside. The filter selector 332 selects one of a plurality of filters stored in the filter-set storage unit 331 and outputs filter coefficients that correspond to the filter to the filter coefficient controller 334. The filter coefficient controller 334 adjusts the filter coefficients according to the environmental parameters output by the parameter controller 333, and outputs final filter coefficients to the convolution and image processor 340.

The convolution and image processor 340 covers the input picture (basic OSD data) 500 with the filter having the final filter coefficients, as shown in FIG. 5B, in order to filter a pixel in the first row and first column, such that the output value of the pixel a is transformed by the following:
(1×0)+(1×0)+(1×0)+(1×0)+(3×a)+(1×b)+(1×0)+(1×1)+(1×m)

Referring to FIG. 5C, the same filter as in FIG. 5B is also applied to the basic OSD data 500 to obtain an output value of the pixel b in the first row and second column that is calculated using the following:
(1×0)+(1×0)+(1×0)+(1×a)+(3×b)+(1×c)+(1×1)+(1×m)+(1×n)

Referring to FIG. 5D, the filter is applied again to the basic OSD data 500 to obtain an output value of the pixel c in the first row and third column that is calculated using the following:
(1×0)+(1×0)+(1×0)+(1×b)+(3×c)+(1×d)+(1×m)+(1×n)+(1×o)

Referring to FIG. 5E, the filter is applied again to the basic OSD data 500 to obtain an output value of the pixel I in the second row and first column that is calculated using the following:
(1×0)+(1×a)+(1×b)+(1×0)+(3×l)+(1×m)+(1×0)+(1×w)+(1×x)

In this manner, the convolution and image processor 340 performs convolution and a variety of image processes on the basic OSD data using the filter coefficients output by the filtering unit 330, resulting in transformed OSD data, and outputs the transformed OSD data to the mixer 350, where the transformed OSD data is mixed with video data to be displayed.

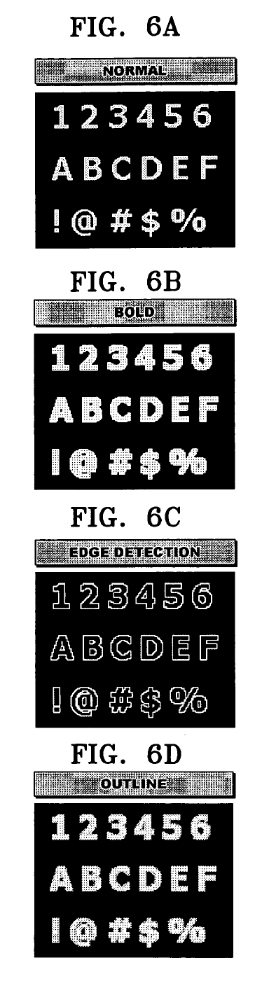

FIG. 6A shows basic OSD data displayed with no effects.

FIGS. 6B through 6D show transformed OSD data displayed with various effects achieved by using various filters.

In FIG. 6B, the transformed OSD data is displayed in bold font created by applying a bold effect to the basic OSD data.

In FIG. 6C, the transformed OSD data is displayed as only edges by applying an edge detection effect to the basic OSD data.

In FIG. 6D, the transformed OSD data is displayed with outlining created by applying an outline effect to the basic OSD data.

Compared to the conventional art where various fonts for OSD data should be previously stored in memory, the present invention processes basic OSD data, transforming it to create a desired effect such as altering the font, only when it is required, and therefore requires less memory capacity.

Note that the present invention is not limited only to the above-described convolution method, and can employ various other image processing methods to process and transform the OSD data.

As described above, according to the present invention, various effects can be added to the basic OSD or graphics data by one-dimensional or two-dimensional image processing filters, according to display device-related and user-determined conditions. This eliminates the need to store in-advance numerous fonts for displaying OSD or graphics data, and therefore requires less memory.

It is possible for the method of processing OSD data described above according to the present invention to be implemented as a computer program. Codes and code segments constituting the computer program may readily be inferred by those skilled in the art. The computer programs may be recorded on computer-readable media and read and executed by computers. Such computer-readable media include all kinds of storage devices, such as ROM, RAM, CD-ROM, magnetic tape, floppy discs, optical data storage devices, etc. The computer readable media also include everything that is realized in the form of carrier waves, e.g., transmission over the Internet. The computer-readable media may be distributed among computer systems connected to a network, and codes on the distributed computer-readable media may be stored and executed in a decentralized fashion.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of processing on-screen display (OSD) data, the method comprising processing basic OSD data to generate processed OSD data that can be displayed with a certain visual effect.

2. The method of claim 1, wherein the processing the basic OSD data comprises performing convolution on the basic OSD data.

3. The method of claim 2, wherein the performing the convolution comprises:
providing filter information; and
performing the convolution on the basic OSD data using the filter information.

4. The method of claim 3, wherein the providing the filter information comprises:
selecting a filter to be used for the convolution; and
adjusting filter coefficients of the filter.

5. The method of claim 4, wherein the filter comprises at least one of a filter that creates a border detection effect, a filter that creates an outlining effect, a filter that creates a shading effect, and a filter that creates a blurring effect.

6. The method of claim 1, further comprising mixing the processed OSD data with video data to display a mixed result.

7. An apparatus for processing an on-screen display (OSD) data, the apparatus comprising an OSD processor which processes basic OSD data to generate processed OSD data that can be displayed with a certain visual effect.

8. The apparatus of claim 7, wherein the OSD processor performs a convolution on the basic OSD data.

9. The apparatus of claim 8, wherein the OSD processor comprises:
a filtering unit which provides filter information; and
a convolution and image processor which performs the convolution on the basic OSD data using the filter information.

10. The apparatus of claim 9, wherein the filtering unit comprises:
a filter selector selecting a filter to be used for the convolution; and
a filter coefficient controller adjusting filter coefficients of the filter.

11. The apparatus of claim 10, wherein the filter comprises at least one of a filter that creates a border detection effect, a filter that creates an outlining effect, a filter that creates a shading effect, and a filter that creates a blurring effect.

12. The apparatus of claim 7, further comprising a mixer which mixes the processed OSD data with video data to display a mixed result.
